(19) United States
(12) Patent Application Publication
(10) Pub. No.: US 2008/0218105 A1
(43) Pub. Date: Sep. 11, 2008

(54) Method for Operating a Fuel Pump

(75) Inventor: Arno Wunderlich, Sindelfingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/044,105

(22) Filed: Mar. 7, 2008

(30) Foreign Application Priority Data
Mar. 7, 2007 (DE) 10 2007 011 018.0

(51) Int. Cl. H02P 6/24; F02M 37/08; H02P 23/00

(52) U.S. Cl. 318/362; 123/497

(57) ABSTRACT

In a method for operating a fuel pump of a motor vehicle, the fuel pump is driven by an EC electric motor for conveying fuel in a direction of an internal combustion engine. Accordingly, when no more fuel is required, the EC electric motor of the fuel pump is switched off in such a way that a rotor of the EC electric motor slows down in a defined manner, so that the rotor of the EC electric motor assumes a defined relative position with respect to the stator of the EC electric motor after slowing down.

### CROSS-REFERENCE TO RELATED APPLICATION

This application claims the priority, under 35 U.S.C. § 119, of German application DE 10 2007 011 018.0, filed Mar. 7, 2007; the prior application is herewith incorporated by reference in its entirety.

### BACKGROUND OF THE INVENTION

### Field of the Invention

The invention relates to a method for operating a fuel pump being driven by an EC electric motor for conveying fuel in the direction of an internal combustion engine.

A fuel pump of a motor vehicle, which fuel pump serves to convey fuel in the direction of an internal combustion engine of the motor vehicle, has an EC electric motor for driving the fuel pump. In this case, a fuel pump is driven by its EC electric motor in such a way that, in order to convey fuel in the direction of the internal combustion engine, the powered EC electric motor drives the fuel pump in a defined direction of rotation.

When no more fuel is required in the internal combustion engine, the EC electric motor of the fuel pump is switched off in order to shut down the motor vehicle or its internal combustion engine. In fuel pumps known from practice, the EC electric motor of the fuel pump is, in this case, switched off in such a way that a rotor of the EC electric motor slows down in an undefined manner on account of its moment of mass inertia and stops in an arbitrary relative position with respect to the stator of the EC electric motor. When the internal combustion engine is subsequently started, it is then necessary to first synchronize the rotor and the stator of the EC electric motor, with the result that a certain period of time passes until it is possible to provide a quantity of fuel, which is required for the first ignition operation which is carried out during starting of the internal combustion engine, and a required fuel pressure. The time which is required to synchronize the rotor and the stator of the EC electric motor is regarded as being disadvantageous.

### BRIEF SUMMARY OF THE INVENTION

It is accordingly an object of the invention to provide a method for operating a fuel pump which overcomes the above-mentioned disadvantages of the heretofore-known methods of this general type, which provides a novel method for operating a fuel pump.

With the foregoing and other objects in view there is provided, in accordance with the invention, a method of operating a fuel pump of a motor vehicle. The method includes driving the fuel pump with an EC electric motor for conveying fuel in a direction of an internal combustion engine; and switching off the EC electric motor when no more fuel is required such that a rotor of the EC electric motor slows down in a defined manner, and the rotor of the EC electric motor assumes a defined relative position with respect to a stator of the EC electric motor after slowing down.

Accordingly, when no more fuel is required, the EC electric motor of the fuel pump is switched off in such a way that a rotor of the EC electric motor slows down in a defined manner, so that the rotor of the EC electric motor assumes a defined relative position with respect to the stator of the EC electric motor after slowing down.

According to a second aspect of the invention, when no more fuel is required, the EC electric motor of the fuel pump is switched off in such a way that a rotor of the EC electric motor slows down in an undefined manner, with at least one coil pair of the stator of the EC electric motor then being supplied with power in such a way that the rotor of the EC electric motor assumes a defined relative position with respect to the stator of the EC electric motor.

Both aspects of the present invention share the common feature that the required quantity of fuel and the required fuel pressure can be provided within an extremely short period of time for the first ignition operation during starting of the internal combustion engine.

According to a first aspect of the present invention, the EC electric motor of the fuel pump is switched off in such a way that the rotor of the EC electric motor slows down in a defined manner, so that the rotor of the EC electric motor assumes a defined relative position with respect to the stator of the EC electric motor after slowing down.

According to a second aspect of the present invention, the rotor of the EC electric motor slows down in an undefined manner, but, after slowing down, at least one coil pair of the stator of the EC electric motor is supplied with power in such a way that the rotor of the EC electric motor is moved to the defined relative position with respect to the stator of the EC electric motor.

Therefore, the required quantity of fuel and the required fuel pressure for the first ignition operation can be provided within an extremely short period of time in both cases.

In accordance with an added mode of the invention, there is the step of varying a circulating magnetic field of the stator of the EC electric motor such that a rotational speed of the rotor is reduced, preferably continuously, and the rotor stops in the defined relative position with respect to the stator of the EC electric motor.

In accordance with another mode of the invention, there is the step of stopping a circulating magnetic field of the stator of the EC electric motor in a defined position to stop the rotor of the EC electric motor in the defined relative position with respect to the stator of the EC motor.

With the foregoing and other objects in view there is further provided, in accordance with the invention, a method of operating a fuel pump of a motor vehicle. The method includes the steps of: driving the fuel pump by an EC electric motor for conveying fuel in a direction of an internal combustion engine; switching off the EC electric motor of the fuel pump when no more fuel is required such that a rotor of the EC electric motor slows down in an undefined manner; and subsequently supplying at least one coil pair of a stator of the EC electric motor with power such that the rotor of the EC electric motor assumes a defined relative position with respect to the stator of the EC electric motor.

In accordance with a further mode of the invention, there is the step of supplying the at least one coil pair of the stator with power, immediately following the undefined slowing down of the rotor, such that the rotor assumes the defined relative position with respect to the stator.

In accordance with a concomitant mode of the invention, there is the step of supplying the at least one coil pair of the stator with power, immediately before the internal combustion engine is started, such that the rotor assumes the defined relative position with respect to the stator, specifically triggered by a motor vehicle locking system being unlocked.

Other features which are considered as characteristic for the invention are set forth in the appended claims.

Although the invention is illustrated and described herein as embodied in a method for operating a fuel pump, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a signal flowchart showing a first aspect of a method of operating a fuel pump according to the invention; and

FIG. 2 is a signal flowchart showing a second aspect of the method for operating the fuel pump according to the invention.

### DETAILED DESCRIPTION OF THE INVENTION

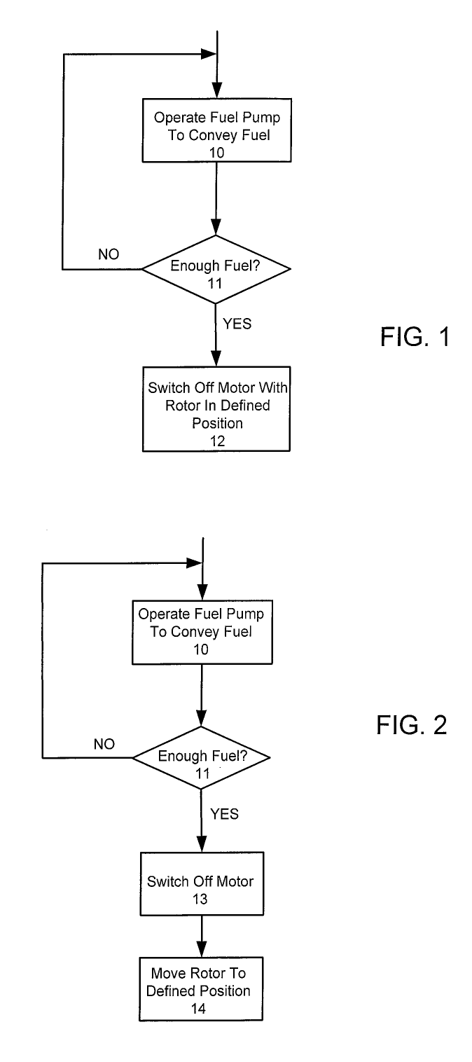

The present invention relates to a method for operating a fuel pump of a motor vehicle. A fuel pump of this type is driven by an electric motor. Operation of the fuel pump by the electric motor in order to convey fuel in the direction of an internal combustion engine is represented by block 10 in FIG. 1. In the text which follows, it is assumed that the fuel pump is driven by an EC electric motor.

In a following block 11, a check is made to determine whether more fuel is required. If it is established in the following block 11 that no more fuel is required, the method branches to block 12 and the EC electric motor of the fuel pump is switched off in block 12. If, in contrast, it is established in block 11 that fuel is still required, the method branches back to block 10.

In order to provide the fuel pressure which is required for the first ignition operation and the required quantity of fuel within the shortest possible period of time during starting of a motor vehicle, a first aspect of the present invention proposes that, when the fuel pump is first shut down, the EC electric motor of the fuel pump is switched off according to block 12 in such a way that a rotor of the EC electric motor slows down in a defined manner, so that the rotor assumes a defined relative position with respect to the stator of the EC electric motor after slowing down.

For this purpose, the circulating magnetic field of the stator is, in the case of an EC electric motor, varied in block 12 in such a way that a rotation speed of the rotor is reduced, preferably continuously, and the rotor stops in the defined relative position with respect to the stator of the EC electric motor. This change in the magnetic field of the stator overrides the controller of the EC electric motor. The circulating magnetic field of the stator of the EC electric motor is stopped at a defined angular position, so that the rotor of the EC electric motor stops in defined relative position with respect to the stator.

On account of the so-called detent torque of the rotor, this defined relative position of the rotor with respect to the stator is maintained even when the magnetic field of the stator is subsequently completely switched off.

The first aspect of the present invention accordingly proposes varying and stopping the circulating magnetic field of the EC electric motor in a defined manner when the EC electric motor is switched off in block 12, so that the rotor stops in a defined relative position with respect to the stator. The rotor is then oriented in a defined manner in relation to the stator, so that the required fuel pressure and the required quantity of fuel can be provided within an extremely short period of time for the first ignition operation during subsequent starting. The inventive method according to the first aspect of the present invention is used particularly when the fuel pump is operated by an EC electric motor with an integrated position sensor.

According to a second aspect of the present invention, when it is established in block 11 of the signal flowchart of FIG. 2 that no more fuel is required, the EC electric motor of the fuel pump is switched off in block 13 in such a way that the rotor first slows down in an undefined manner, with at least one coil pair of the stator then being supplied with power in block 14 in such a way that the rotor is moved to a defined relative position with respect to the stator of the EC electric motor and assumes this relative position. If, in contrast, it is established in block 11 that fuel is still required, the method branches back to block 10, in line with the signal flowchart of FIG. 1, and the fuel pump is further driven by the EC electric motor.

The rotor can be moved to a defined relative position with respect to the stator of the EC electric motor according to block 14 either immediately following the undefined slowing down of the rotor or immediately before an engine is subsequently started.

When the rotor is moved in relation to the stator of the EC electric motor immediately before the engine is started, the corresponding supply of power to the electric motor is preferably triggered by a motor vehicle locking system being unlocked.

Therefore, after a motor vehicle door is unlocked, the rotor can be immediately moved to the defined relative position with respect to the stator by the stator of the EC electric motor being correspondingly supplied with power, so that, during subsequent starting, the rotor assumes the relative position with respect to the stator and the fuel pressure which is required for the first ignition operation and the correspondingly required quantity of fuel can accordingly be provided within the shortest possible period of time.

In this context, it is also possible to operate the fuel pump, specifically the EC electric motor of the fuel pump, in a low rotation speed range after the motor vehicle locking system is unlocked, in order to thus fill the fuel system of the motor vehicle and build up a defined fuel pressure before the internal combustion engine is actually started. As a result, noise produced by the fuel pump when the internal combustion engine is not running can be reduced. Furthermore, the fuel pressure which is required for the first ignition operation and the required quantity of fuel can be provided even more quickly.

The method according to the invention accordingly ensures that, when an internal combustion engine is started, the position of the fuel pump, specifically the relative position between the stator and the rotor of the EC electric motor of the fuel pump, is known, so that it is not necessary to synchronize the stator and the rotor. As a result, the start time for the internal combustion engine can be reduced since the fuel pressure which is required for the first ignition operation and the required quantity of fuel can be provided within an extremely short period of time.

1. A method of operating a fuel pump of a motor vehicle, which comprises the steps of:
driving the fuel pump with an EC electric motor for conveying fuel in a direction of an internal combustion engine; and
switching off the EC electric motor when no more fuel is required such that a rotor of the EC electric motor slows down in a defined manner, and the rotor of the EC electric motor assumes a defined relative position with respect to a stator of the EC electric motor after slowing down.

2. The method according to claim 1, which further comprises varying a circulating magnetic field of the stator of the EC electric motor such that a rotational speed of the rotor is reduced, and the rotor stops in the defined relative position with respect to the stator of the EC electric motor.

3. The method according to claim 1, which further comprises stopping a circulating magnetic field of the stator of the EC electric motor in a defined position to stop the rotor of the EC electric motor in the defined relative position with respect to the stator of the EC motor.

4. The method according to claim 1, which further comprises varying a circulating magnetic field of the stator of the EC electric motor such that a rotational speed of the rotor is reduced continuously and the rotor stops in a defined relative position with respect to the stator of the EC electric motor.

5. A method of operating a fuel pump of a motor vehicle, which comprises the steps of:
driving the fuel pump by an EC electric motor for conveying fuel in a direction of an internal combustion engine;
switching off the EC electric motor of the fuel pump when no more fuel is required such that a rotor of the EC electric motor slows down in an undefined manner; and
subsequently supplying at least one coil pair of a stator of the EC electric motor with power such that the rotor of the EC electric motor assumes a defined relative position with respect to the stator of the EC electric motor.

6. The method according to claim 5, which further comprises supplying the at least one coil pair of the stator with power, immediately following the undefined slowing down of the rotor, such that the rotor assumes the defined relative position with respect to the stator.

7. The method according to claim 5, which further comprises supplying the at least one coil pair of the stator with power, immediately before the internal combustion engine is started, such that the rotor assumes the defined relative position with respect to the stator, specifically triggered by a motor vehicle locking system being unlocked.
